(19) United States
(12) Patent Application Publication
(10) Pub. No.: US 2013/0024512 A1
(43) Pub. Date: Jan. 24, 2013

(54) Feature-extended apparatus, system and method for social networking and secure resource sharing

(71) Applicant: Georgi Milev, Shumen (BG)

(72) Inventor: Georgi Milev, Shumen (BG)

(21) Appl. No.: 13/372,089

(22) Filed: Feb. 13, 2012

Related U.S. Application Data
(60) Provisional application No. 61/442,280, filed on Feb. 13, 2011.

(51) Int. Cl. G06F 15/16

(52) U.S. Cl. 709/204

(57) ABSTRACT

A feature-extended apparatus, system and method for social networking and secure resource sharing is disclosed. The present invention provides advanced capabilities for social networking and secure resource sharing, implemented by one or more subsystems. Subsystems exist for provisioning effective social interactions; generating inferred social value metrics; searching and browsing a multitude of subjects by various criteria, including but not limited to subject-provided data and inferred social value metrics; provisioning of the security and access control of plurality of passive data items with respect to a plurality of active subjects; security-enabled contingent multicasting of state changes regarding a plurality of passive data items; collecting participants' input for the purposes of interacting with the present apparatus and respectively with other participants; presentation and display of the quantities described hereinabove to a person or a computer system.

### CROSS-REFERENCE TO RELATED APPLICATIONS

This application claims priority from U.S. provisional patent application No. 61/442,280 filed Feb. 13, 2011

### FIELD OF THE INVENTION

This invention relates to techniques for providing a user of a social networking and/or a resource sharing system with a way to access the most socially compatible eventual interlocutors and peers; a way to share only the needed-to-know information by those peers; or resources in general.

### BACKGROUND OF THE INVENTION

Due to their inherent nature, people need to communicate with each other, be it for personal and leisure purposes, e.g. finding a compatible mate, friend, colleague; be it for commercial purposes, whereby for example a corporation wishes to advertise itself to its potentital stakeholders.

With the advent of the world wide web, social networking websites have arisen into prominence—dating sites, classmate databases etc. However those introduce problems such as when a dating site is being browsed for potential mates, much of the results are being noise, which is sought to be eliminated.

A plurality of social networking websites have attempted to solve problems, in the most cases have failed and likewise have introduced problems their own, such as users in general indirectly being made reluctant to respond to a friend request in those environments, because of security issues: nobody wants their private information to be available to everyone, as well as the right for others to transmit information to their public profile; or the entirety of their contacts to develop into a clique, and would like to retain a quantity of relative betweenness instead.

The prior art of security subsystems in social networking environment is inflexible. Some social networking websites have attempted to solve that problem and have partially succeeded, but their weakness is that the social groups the subsystem makes possible to arise, necessarily have the ability to form potential cliques, which is not always desirable. It is not always desirable for a person, even to be aware that he is a member of a group, as specified in the description.

Also, it is a huge problem for users being stalked, e.g. by an ex-mate or employer or parents.

In addition, in that matter, static personal information can be protected by that security subsystem, as further described below.

If a current social networking website displays multicast updates information, then it provides only certain level of relevance at most, which is also static.

No social networking website currently provides information for the extent to which a person is important in a network, as well as a way for people to be searched by various criteria and only the most relevant and featured results to be displayed.

No social networking website currently provides a way for a user to advertise his interests, qualities, and properties in a concise, short way, especially for them to be assumed by other parties and for them to become publicly available for display on the other party's profile, as well as metrics derived from those qualities.

No social networking website currently provides a way for two parties to know their mutual bidirectional social compatibility.

### SUMMARY

Contrary to the the prior art, whereby one can join an objective symmetric group, that is a clique, the present invention provides a subject with a way to classify other participants as members of a subjective asymmetric group, that is a group instance referenced by name means different set of participants to each subject, e.g. John has classified Alice, Bob, Eve and Jane as members of his inner social circle, and Jane-Alice, Bob and John, leaving Eve out of Jane's inner social circle and thus multicasting state changes to the abstract category of “their respective inner social circles” leads to different outcome for each of John and Jane.

One may multicast a plurality of state changes to multiple groups. E.g. one says “Good morning!” to the inner social circle and his colleagues at work, which are both asymmetric groups, but later says to his social circle “There is a party tonight at 23 h at my place”, thus discriminating social groups based on their real life social functions with respect to the subject.

Static personal information items can be also associated with a set of subjective asymmetric groups.

One may provide a set of criteria by which to look up potential contacts, and request that the results are returned in a sorted fashion by their social quality.

The extent to which a person is important in a network may be displayed in numerical fashion, normalized or not.

One may provide a set of criteria associated with his social profile, so that on contacting arbitrary parties via the present invention, one is displayed a metric for their mutual bidirectional social compatibility in numerical fashion, normalized or not.

One may easily, via a special interface control, to assume one or more characteristics associated with another's social profile, thus increasing his search exposure and eventualy instances of the mutual bidirectional social compatibility metric. As a consequence, social recommendation engines can be easily integrated with this richer, more qualified and more targeted audience.

Additional aspects, applications and advantages are provided by the following description and associated figures.

### BRIEF DESCRIPTION OF THE DRAWINGS

FIG. 1 describes the core subject data structures

FIG. 2 describes the core security data structures

FIG. 3 describes the security-enabled photo sharing data structures

FIG. 4 describes the taxon data structures

FIG. 5 describes the security-enabled messaging and multicasting data structures

FIGS. 6 and 7 describe the group creation screen

FIG. 8 describes the ResourcePermission institution screen

FIG. 9 describes the Group selection screen

FIG. 10 is a diagram of the mutual bidirectional social compatibilities display screen

FIG. 11 is a sample display screen of a security-enabled messaging and multicast summary

### DETAILED DESCRIPTION OF THE INVENTION

Anyone with ordinary skills in computer programming and database administration should comprehend this document.

In the following description of the invention, reference is made to the accompanying drawings which form a part hereof, and in which it is shown by way of illustration specific embodiments in which this invention can be practiced. It is to be understood that other embodiments can be utilized and structural changes can be made without departing from the scope of the invention.

The term “database” in will hereinafter mean an abstract computer storage system, comprised of one or more physical servers (or a server farm) provisioned with appropriate software packages, such as relational database management systems, nosql database systems, or whatever necessary software.

“Entity” will hereinafter mean a record in a relational database or its equivalent in non-relational or any kind of databases; with or without any of its related entities. Every definition, having a Long id field, is an entity definition. The inverse is also true.

“String” will hereinafter mean a string of charaters.

“Persist” will hereinafter mean storing an entity into a database, via execution of the respective subroutine of that database.

“Remove” will hereinafter mean removing an entity from a database, via execution of the respective subroutine of that database.

An “application” will hereinafter mean any software package, client or server, related to and developed in compliance with this apparatus' standard application programming interface.

“Is” may hereinafter mean object-oriented declaration of the parent class or type; or a “same” entity.

“Has” may hereinafter mean object-oriented declaration of the fields of the current class; a database relation, whereby one entity refers to another. The entity who “has” may be the owning side, or may be the inverse side of the relationship.

“Is” or “has” may not necessarily relate to any implementation whatsoever, but may describe abstract hierarchical concepts in general; may be used in other morphological forms (e.g. having, be).

Every field declaration in the figures, that is not Long, String, Boolean, Date, Set<any>, is a many-to-one relation of the respective entity type.

Every Set<any> is a one-to-many relation.

Every id field, unless stated otherwise, is assigned a value by the database.

The plural form of an entity name means a plurality of entity instances of the respective type, e.g. ‘Comments’ is a plurality of instances of type Comment.

‘Same’, in the context of entities, may mean two or more entities that are equal under their primary keys, or in other cases under two or more fields that are sufficient to identify uniquely and meaningfully the concept the entity designates in its respective functionality context.

‘Owner’ may be a synonym for ‘authority’.

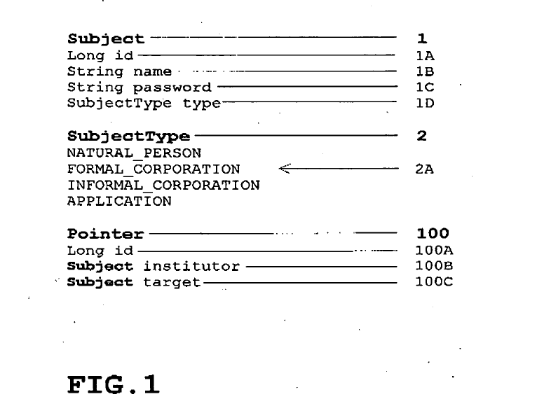

FIGS. 1-5 are descriptions of the abstract database schema in an abstract pseudocode.

FIG. 1 describes the core subject entities. Each Subject 1 is a anyone and anything using the apparatus by means of graphical user interface, or application programming interface.

He has an id 1A, name 1B, password 1C, SubjectType 1D. It may be a natural person, a formally registered corporation; or an informal one, it may be an application 2A.

Subject 1 entities are dynamically created via a standard subject registration screen.

SubjectTypes 2 are staticly defined (hardcoded), although additional ones may be added as extensions to the apparatus and cannot necessarily be specified in advance in this document.

A directed Pointer 100 can be instituted by one Subject 1 to another, via a toggle control on the latter's profile. A Pointer 100 designates the binary willingness of the institutor to socially support the Pointer target 100C.

For each Subject, based on the Pointer 100 graph, an eigenvector centrality measure is calculated iteratively and indefinitely until when sorted by centrality, the subjects reach monotonically increasing centrality measures at maximum of the points. Then the whole sorted set of Subjects by the centrality measure is considered in an descending manner. Then for each Subject, a normalized social quality score S can be displayed after being calculated as follows and is persisted in the database:
c=total Subjects count
i=the zero-based array index of the Subject in the sorted set of descending centrality measures

S=ceil((1−i/c)*100]

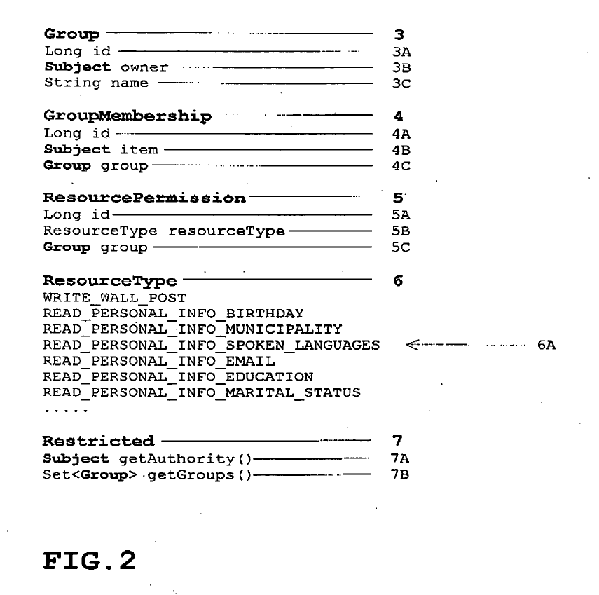

FIG. 2 describes the assymetrical grouping of subjects and the security subsystem in general.

This subsystem is tightly coupled conceptually and technically with the multicasting subsystem.

A Group designates quantities that are common to a set of capability-enabled subjects. It is represented by an, entity 3, having an id 3A, owner 3B and name 3C.

The set itself is represented by a plurality of GroupMembership 4 entities. Each of them has an id 4A; item 4B, which is the subject that is member of the specified group; target group 4C.

A ResourceType 6 instance is a single capability type that a Group has clearance for. ResourceTypes may be those of 6A, or others. Other ResourceTypes may be added as extensions to the apparatus and cannot necessarily be specified in advance in this document.

Clearance is granted by means of persisting an entity of ResourcePermission 5, having an id 5A; ResourceType 5B; target group 5C.

When a user (Subject 1) undertakes an action (more formally, when attempting to access a resource, defined by 6A) with respect to another, the former may be a subject to a clearance check. It happens as follows:

A database query is initiated of whether there exists an entity 5 having 5B corresponding to the respective action, and having 5C such that the former subject is a member of that group. If true, then the former subject is considered to be enabled to complete the action undertaken.

A plurality of entity types can be Restricted 7, i.e. implement the contract of 7A and 7B. Restricted is the means by which the apparatus can be extended for enabling other entity types for security. 7A is the person who owns this resource and has authority over it, and likewise 7B is the set of groups, the participants of which are to be multicast the Restricted 7 instance.

Every group contained in 7B is owned by the Restricted's authority 7A.

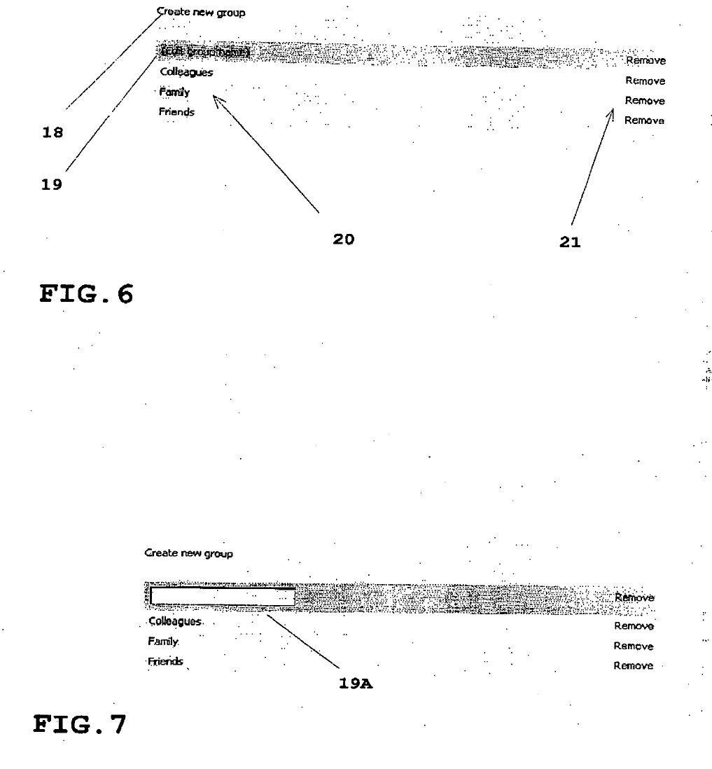

Groups 3 are dynamically created via a screen like the one shown in FIG. 6 and it happens like this:

Referring now to FIGS. 6 and 7, the apparatus user (subject) clicks on the interface control 18 and then the control 19 shows as a result. It is a placeholder for the new group name 3C to be provided as input, as a guideline for the user to click on it and to enter the desired input. On click on 19, it transforms into a text field 19A. This step can be omitted, and thus the control 19A to be shown directly on click on 18.

The graphical interface part 20 designates the existing groups names.

The graphical interface part 21 is comprised of controls for removal of existing groups. On error, a ‘Remove’ label of 21 is replaced with an error message.

A group selection is a set of groups 3 selected by the following process;

A selection control in a separate dialog window or embedded in the main screen is shown just like in FIG. 9. The user selects any subset of the groups listed as available in the box 24 and as a result they appear as selected in the box 23. When ready, the user clicks on the control 25 and thus confirms the group selection.

In various conversation contexts, a group selection initiation control (e.g. a button) can be shown, e.g. next to a target. Subject's name 18 or whatever related information that has ‘name’ semantics, and for each selected group, a GroupMembership 4 entity is persisted, where the item 4B is set to the target Subject 1 and the group 4C to the respective group of the group selection.

I.e. in some contexts, on click on a subject name, a control can be shown for populating a plurality of Groups with the given subject.

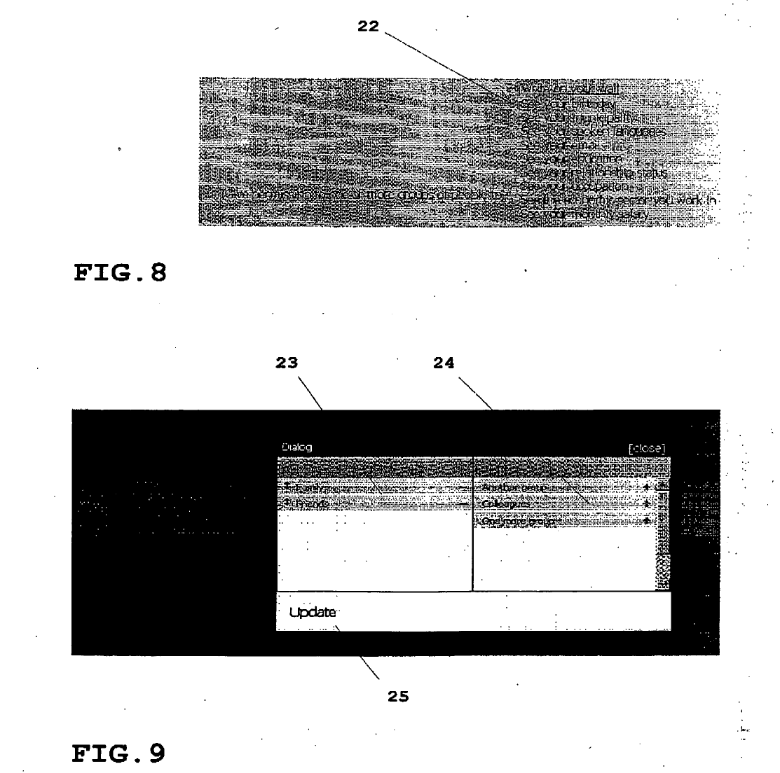

FIG. 8 illustrates the process of giving ResourcePermissions 5.

A group selection is made. Then for each group a plurality of ResourcePermissions 5 is persisted, where the resource type 6 is the one selected from 22 and the group 5C is the respective group from the group selection.

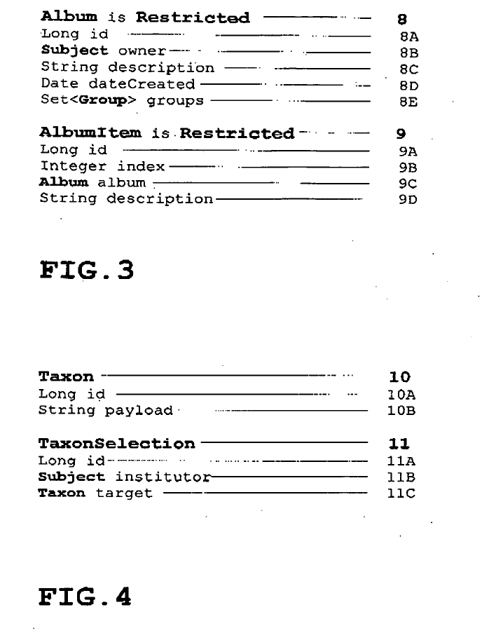

FIG. 3 describes the photo storage subsystem. It is security enabled.

An Album entity 8 is Restricted. It has an id 8A; owner 8B, as specified in 7A; description 8C; dateCreated 8D; set of groups 8E, as specified in 7B.

An Album designates quantities that are common to a set AlbumItems 9.

AlbumItems 9 are Restricted and have an id 9A; index 9B, which is the logical order designator of the album item with respect to the album; target album 9C; description 9D.

AlbumItem 9 implements the Restricted contract, where the return values of 7A and 7B are respectively the AlbumItem's Album 9C owner 8B and its Album 9C groups 8E.

Albums 8 are created like this:

A group selection is made. Then each group is added to the then empty set 8E. The owner 8B is set to the current Subject 1 and is the authority 7A, the description 8C is gathered from the album creation screen. The dateCreated 8D is set to the current time.

AlbumItems 9 are created by means of a standard file upload screen implicitly associated with a particular current Album 8.

The index 9B is set to the current AlbumItems count of the current album. A description 9D can be provided via that file upload screen.

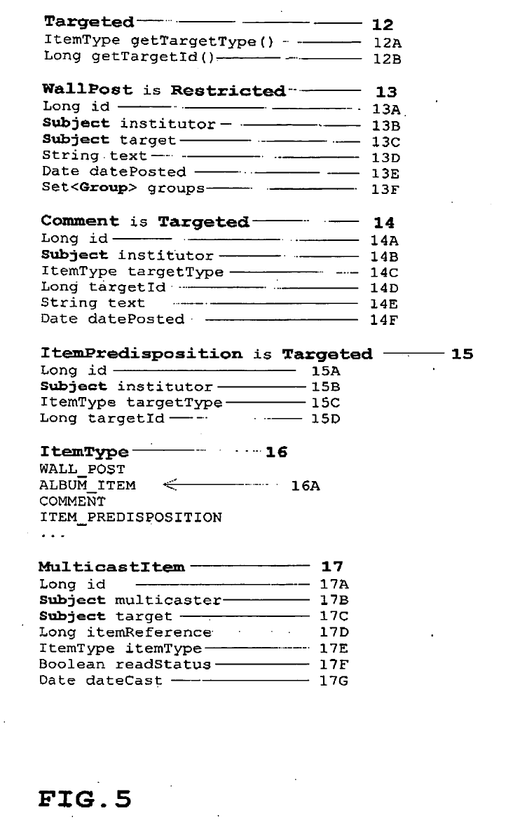

FIG. 5 describes the social communication and multicasting subsystem.

Targeted 12 is a common contract 12A and 12B implemented by all the social qualifiers that are assigned to a subject from another subject, e.g. Comments, ItemPredispositions.

ItemType 16 is the logical type for any social networking item. Multiple ItemType instances exist. Common ones are 16A. Other types may be added as extensions to this apparatus in a manner similar to ResourceType 6, as specified hereinabove.

A WallPost 13 is Restricted and has an id 13A; institutor 13B; target 13C which acts as 7A; text 13D; datePosted 13E; set of groups 13F, as specified by 7B.

It designates a basic entity, like text or image, attached to a target subject's profile.

An institutor 13B and target 13C may be the same entity.

A WallPost 13 is created by means of a screen consisting of a text field, a group selection initiation control, and a confirmation control.

After making a group selection, the WallPost fields are populated as follows;

the institutor 13B becomes the current Subject 1;

the target 13C becomes the target Subject 1;

the text gathered from the screen's text field is assigned to the text 13D;

datePosted 13E becomes the current time;

the groups 13F are assigned the value of the group selection.

A Comment 14 is Targeted and has an id 14A, institutor 14B, target type 14C, target id 14D, text 14E, date posted 14F. It designates a single of one or many instances of text associated with a particular item, i.e. the entity having the target id 140 as primary key and is of type targetType 14C.

A Comment 14 is created by means of a screen consisting of a text field, and optionally an explicit confirmation control. A comment is implicitly related to a Restricted 7. After entering the comment text in the text field and confirming the comment, fields of the Comment 14 are populated as follows:

institutor 14B becomes the current Subject 1;

targetType 14C becomes the ItemType 16 of the associated Restricted 7;

targetId 14D becomes the Restricted's id.

An ItemPredisposition 15 is Targeted and has an id 15A, institutor 15B, target type 15C, target 15D. An entity of this type refers to one subject having predisposition or inclination to a particular item, i.e. the entity having the target id 15D equal to its own id and is of type targetType 15C.

An ItemPredisposition 15 is created by means of a screen consisting of a confirmation control, associated with a particular Restricted 7.

The fields of the ItemPredisposition 15 are populated as follows: institutor 15B becomes the current Subject 1;

targetType 15C becomes the ItemType 16 of the associatcd Restricted 7;

targetId 15D becomes the Restricted's id.

A MulticastItem 17 has an id 17A, multicaster 17B, target 17C, item reference 17D, item type 17E, read status 17F, date cast 17G.

For each item 7 that is multicast, the number of newly persisted entities is equal to the number of distinct Subjects 1 in all Groups 7B assigned to that item.

When instituting a Restricted 7, a multicast is initiated as follows:

After the group selection is made, if no groups are explicitly selected, then an implicit group is returned, consisting of all Pointer institutors 100B, where the target 100C is the Subject 1, owner of the target profile.

For each Subject 1 that is member of those groups (via GroupMemberships 4 in case there are explicit groups), a MulticastItem 17 is persisted, where:

the multicaster 17B is the current Subject 1;

the target 17C is the respective member of those groups;

the itemReference 17D is the id of the Restricted 7;

the itemType 17E is the ItemType 16 of the Restricted 7;

readStatus 17F is set by default to false;

dateCast 17G is set to the current time.

When instituting a Targeted 12, a multicast is initiated as follows:

the Restricted 7 target entity, identified by the

ItemType 12A and target id 12B is fetched.

The groups 7B of the Restricted 7 are fetched. If no groups are explicitly selected, then an implicit group is returned, consisting of all Pointer institutors 100B, where the target 100C is the Restricted's authority 7A.

For each Subject 1 that is member of those groups (via GroupMemberships 4 in case there are explicit groups), a MulticastItem 17 is persisted, where:

the multicaster 17B is the current Subject 1 or the Restricted's authority 7A, depending on context or system settings;

the target 17C is the respective member of those groups;

the itemReference 17D is the target id 12B;

the itemType 17E is the ItemType 12A;

readStatus 17F is set by default to false;

dateCast 17G is set to the current time.

Referring now to FIG. 11, a structured multicast summary is presented.

The multicast summary consists of the subject name 30, number 31 of multicast items received from every subject via the process described hereinabove, and the normalized social score S 32. All the results are sorted by S.

The subject name 30 is, in addition, a control for initiating a display of all the Restricted 7 items corresponding to the respective MulticastItems 17.

Additional fields relevant to a given subject may be presented in the summary.

Similarly to the display process corresponding to FIG. 11, a Subject search can be performed.

One or more criteria are specified, including but not limited Lo standard Subject personal information, a set of taxons to search by, a set of social metrics [C(a,b); S; etc.]. All results are ordered by S or C.

The fields displayed include, but are not limited to:

Subject name, date of last activity, control for displaying the corresponding profile page of that subject, score S, score C(a,b), a toggle control for instituting a Pointer 100.

FIG. 4 describes the taxon provisioning subsystem with respect to subjects.

A Taxon 10 is the entity designating taxons. Its instances are canonical and have an id 10A and payload 10B.

Assignment of taxons to subjects is implemented by means of the TaxonSelection entity 11, which has an id 11A; institutor 11B; target 11C.

I.e. each subject has a set of taxons.

An inverted index may be created for the purposes of optimizing the search operations by taxons. Search operations may be performed by standard SQL SELECT query that orders results by the subject quality metric; or by a semantically equivalent database operation for a large data set database system.

Regarding FIG. 4, every Subject 1 has an associated logical set of taxons with his profile.

That association is performed by means of a text area in his profile (for input) where a CSV list of values is provided. Then that CSV list can be parsed and the values—canonicalized by means of the Taxon 10 entity type. Each value from the CSV list becomes the payload 10B. Then for each canonical member of the CSV list a TaxonSelection is persisted where the target Taxon 11C becomes the canonical one and the institutor 11B becomes the current Subject 1.

As output, the CSV can be displayed as a simple graphical interface label.

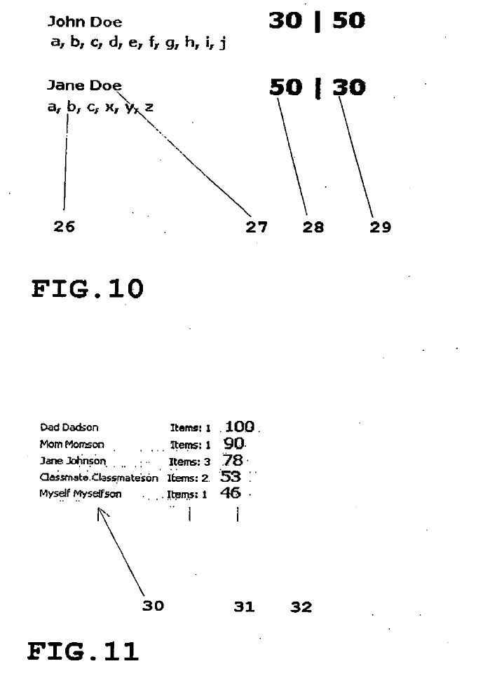

Referring now to FIG. 10, 2 Subjects 1 with their respective sets of taxons 26, names 27 and their mutual bidirectional social compatibility factors—28 and 29, displayed as percentages.

Those compatibility metrics are calculated as follows:

For each two subjects A and B, there are the quantities

M=taxon set size of A

N=taxon set size of B

Q=taxon set intersection size of A and B.

Then the metric of:
a Subject A being compatible to Subject B (or the probability that B would like A) is equal to Q/M [real number from 0 to 1];
a Subject B being compatible to Subject A (or the probability that A would like B) is equal to Q/N [real number from 0 to 1].

Additional metric of mutual compatibility can be calculated as follows:

C(A, B)=Q̂2/MN [real number from 0 to 1]

This metric can be displayed in addition to 28 and 29 for each pair of Subjects 1.

In addition, alongside its absolute form, this metric can be displayed in its normalized form, relative to the compatibility metrics of the other pairs of Subjects.

For example, lets consider those Subjects with their respective taxon sets:

A has [a, b, c, d, e];

B has [a, b, e];

C has [b, c].

C(A,B)= 9/15=60% [abs]=100% [norm]

C(A,C)= 4/10=40% [abs]=66% [norm]

C(B,C)=⅙=16.6% [abs]=27% [norm]

By analogy these social compatibility metrics can be calculated for each pair of items having a set of taxons; for pairs of entire blocks of text, where each word may be canonicalized/indexed.

By analogy these social compatibility metrics can be calculated for each pair of subjects, having a set of items published, where each of those items has a set of taxons itself. It can be done like this:

For each of the pair of subjects, a map of Taxon to integer is created. For each item published, the map is checked for containment of each Taxon as a key. If false, then a mapping from the given taxon to an integer, being by default 1, is created. If true, then the mapped integer is incremented.

The intersection size is calculated as follows: for each key in a given map, it is checked for containment in the other map. If true then the intersection size summand for this key is equal to the lesser or equal integers under the given key in each of the maps. Then, for each key satisfying the above condition, the intersection summands are summed, and the result is the intersection size.

For example:

Subject A has 3 songs—a, b and c, having respectively taxons (a:(1, 2, 3), b:(1, 2), c:(3, 4)]

Subject B has 3 songs—d, e and f, having respectively taxons [d:{1, 2}, b:{1}, c:{3, 5, 6}]

The respective maps are:

A—{1:2; 2:2; 3:2; 4:1}

B—{1:2; 2:1; 3:1; 5:1; 6:1}

where the intersecting keys are: 1, 2, 3.

The lesser or equal sizes (intersection summands) under those keys are:

[1:2; 2:1; 3:1]—and thus

the total intersection size Q is 2+1+1=4.

M and N are respectively 7 and 6.

Thus in this case:

C(A,B)= 16/42=38%

The social compatibility metrics can also be scaled logarithmically.

Referring again to FIG. 10, a Subject 1, e.g. Jane Doe, having seen that another, e.g. John Doe has interests in ‘g’, and after having researched the topic, and then after having liked it, she decides that she wants to update her profile with that taxon ‘g’, so that she can identify with it and so that other people can search for her by it.

She doesnt have to go to her profile and go through several pages so that she can update her profile. She can just click on the control of ‘g’, whereby her profile eventually is either updated, or shown a confirmation control whether she wants to update herself with this taxon or directly search for other people by it.

In addition to the aforementioned aspects, the preferred embodiment of this apparatus is comprised of any additional potential input and output devices, graphical user interfaces, application programming interfaces, physical networking environment, any associated telecommunication mediums and an underlying operating system.

Subsets of the features, described herein, as well as additional features can be present in alternative embodiments of this invention.

In addition, graphical user interfaces described hereinabove are mentioned as an example embodiment, an for illustration of the structure of the input data collected, but there may exist embodiments that implement a drag and drop or other functionality that still fulfills the requirements or usefulness and the purpose of the present invention.

What is claimed is:

1. A computer implemented system for introducing social networking participants to other ones with dynamically selected convenient characteristics.

2. A system of claim 1, supporting a plurality of characteristics comprising: high objective social quality; high likelihood of being a favorable social match; and performing one or more desired functions in said participants' life.

3. A system of claim 1, further comprising a method for gathering social networking participants' taxonomic data, analysis thereof and display of consequent social compatibility metrics comprising: a forward; a backward; and a mutual one.

4. A system of claim 1, further comprising a method of gathering social networking participants' interconnection graph, analysis thereof and display of a consequent social quality score, comprising an eigenvector centrality as a preferred embodiment.

5. An apparatus for social networking, implementing the system of claim 1, said apparatus being comprised of software, its respective execution environment with the necessary memory and processing units, a networking interface, routing infrastructure, input and output devices as parts of its preferred embodiment.

6. A system of claim 1, further implementing a method for calculating, storing and displaying a compatibility metric of two or more social networking participants, each having a set of taxons.

7. A system of claim 1, further implementing a method for calculating, storing and displaying a compatibility metric of two or more social networking participants, each having a set of arbitrary items, each item having a set of taxons.

8. A system of claim 1, further comprising a method and graphical user interface for profile enhancement by one-click taxon copying from a foreign profile into an own profile.

9. A system of claim 1, further implementing a method and a social networking graphical user interface for gathering, sorting, updating, reading, displaying, storing and removal of representations of people from sets in the event of change of a particular member's function in an user's life, said function being an eventual dynamically selected characteristic.

10. A system of claim 9, further comprising a method for multicasting information bits only to an own set, an union of own sets of people in a social networking setting, said sets dynamically selected by the multicaster.

11. A system of claim 9, further comprising a method for multicasting information bits only to a set or an union of sets of people in a social networking setting, said people being targets of a previous multicast, said sets having already been selected by an initiator of said previous multicast.

12. A system of claim 9, further comprising a method and graphical user interface for fine grained assignment and usage of profile display permissions to a set of people or to an union of sets of people in a social networking setting.

13. A computer implemented system, method and graphical user interface for displaying a set of multicasters that a person has subscribed to, sorted by their social quality.

14. The system and graphical user interface of claim 13, displaying alto other data, comprising a plurality of multicast items count, grouped by the respective multicaster.

15. A system of claim 1, further comprising a method of gathering input social connections data, storing it in an appropriate form, determining a social quality metric upon it in an environment of active subject communication, and displaying it directly or using it as a means for further search results filtering and communication noise removal.

16. A system of claim 1, further comprising a method for results filtering based on the keywords supplied by the user; results filtering by the resulting person's taxon set; and results ordering by social quality, said results being people or organizations.

17. An apparatus of claim 5, also having a web services API
